(19) United States
(12) Patent Application Publication
(10) Pub. No.: US 2020/0313230 A1
(43) Pub. Date: Oct. 1, 2020

(54) ALL-SOLID BATTERY

(71) Applicant: TAIYO YUDEN CO., LTD., Tokyo (JP)

(72) Inventors: Daigo ITO, Tokyo (JP); Takato SATO, Tokyo (JP); Sachie TOMIZAWA, Tokyo (JP); Chie KAWAMURA, Tokyo (JP); Masashi SEKIGUCHI, Tokyo (JP)

(73) Assignee: TAIYO YUDEN CO., LTD., Tokyo (JP)

(21) Appl. No.: 16/780,414

(22) Filed: Feb. 3, 2020

(30) Foreign Application Priority Data
Mar. 28, 2019 (JP) 2019-064300

(51) Int. Cl. H01M 10/0562; H01M 4/80; H01M 4/62

(52) U.S. Cl. CPC H01M 10/0562; H01M 2300/0065; H01M 4/621; H01M 4/803

(57) ABSTRACT

An all-solid battery includes: a multilayer chip having a substantially rectangular parallelepiped shape and including solid electrolyte layers and electrodes alternately stacked, the electrodes being alternately exposed to two edge faces facing each other of the multilayer chip, wherein cover layers are provided between two faces, which face in a stacking direction of the solid electrolyte layers and the electrodes, of four faces other than the two edge faces of the multilayer chip and a cell reaction region where two adjacent electrodes exposed to different edge faces face each other across the solid electrolyte layer, and an active material layer containing an electrode active material is provided between the cover layers and the cell reaction region, no cell reaction occurring between the active material layer and an outermost electrode in the cell reaction region, the solid electrolyte layer being located between the active material layer and the cell reaction region.

### CROSS-REFERENCE TO RELATED APPLICATION

This application is based upon and claims the benefit of priority of the prior Japanese Patent Application No. 2019-064300, filed on Mar. 28, 2019, the entire contents of which are incorporated herein by reference.

### FIELD

A certain aspect of the embodiments relates to an all-solid battery.

### BACKGROUND

Secondary batteries have been used in various fields. Secondary batteries having an electrolytic solution have a problem such as leak of the electrolytic solution. Thus, all-solid batteries having a solid electrolyte and other solid elements are being developed.

In such an all-solid battery field, to increase an energy density, proposed are layered all-solid batteries including a multilayer structure in which two or more cell units (also referred to as unit cells) each including a positive electrode, a solid electrolyte, and a negative electrode are stacked and unified, as disclosed in, for example, Japanese Patent Application Publication No. 2007-80812 and International Publication No. 2018/181379 (hereinafter, referred to as Patent Documents 1 and 2).

### SUMMARY OF THE INVENTION

According to an aspect of the embodiments, there is provided an all-solid battery including: a multilayer chip having a substantially rectangular parallelepiped shape and including solid electrolyte layers and electrodes that are alternately stacked, the electrodes being alternately exposed to two edge faces facing each other of the multilayer chip, the solid electrolyte layers being mainly composed of phosphoric acid salt-based solid electrolyte; and a pair of external electrodes provided on the two edge faces, wherein a pair of cover layers is provided between two faces of four faces other than the two edge faces of the multilayer chip and a cell reaction region, the two faces facing in a stacking direction of the solid electrolyte layers and the electrodes, the cell reaction region being a region where two adjacent electrodes, which are exposed to different edge faces, face each other across the solid electrolyte layer, and an active material layer is provided between the pair of cover layers and the cell reaction region, the active material layer containing an electrode active material, no cell reaction occurring between the active material layer and an outermost electrode of the electrodes in the cell reaction region, the solid electrolyte layer being located between the active material layer and the cell reaction region.

### BRIEF DESCRIPTION OF THE DRAWINGS

FIG. 1 is a schematic cross-sectional view illustrating a basic structure of an all-solid battery;

FIG. 2 is a schematic cross-sectional view of an all-solid battery in accordance with a first embodiment;

FIG. 3 is a schematic cross-sectional view of an all-solid battery in accordance with a second embodiment;

FIG. 4 is a flowchart of a method of manufacturing the all-solid battery;

FIG. 5 illustrates a stacking process;

FIG. 6A and FIG. 6B illustrate a process of forming a cover layer;

FIG. 7A to FIG. 7C illustrate a process of forming a cover layer in accordance with the second embodiment; and

FIG. 8A and FIG. 8B illustrate overall structures of all-solid batteries in accordance with the first embodiment and a first comparative example, respectively.

### DETAILED DESCRIPTION

In the layered all-solid battery, to improve the strength and prevent water penetration it is common to provide cover layers over and under the part generating electric capacitance of the multilayer structure.

The material for the cover layer is preferably a material to be densely sintered at firing temperature of the multilayer structure to prevent water penetration and improve the strength. However, the use of the above material may cause an interdiffusion reaction between the electrode and the cover layer, changing the composition inside the outermost electrode in the multilayer structure to a composition different from the composition inside the electrode near the center of the multilayer structure. There is concern that the change in the composition inside the outermost electrode of the multilayer structure decreases the capacitance of the cell unit, thereby decreasing the capacitance of the all-solid battery as a whole.

Hereinafter, with reference to the accompanying drawings, embodiments will be described.

### First Embodiment

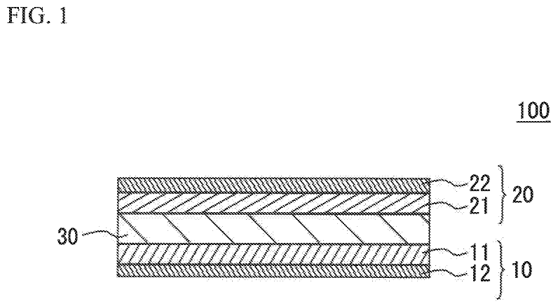

FIG. 1 is a schematic cross-sectional view illustrating a basic structure of an all-solid battery 100. As illustrated in FIG. 1, the all-solid battery 100 has a structure in which a first electrode 10 and a second electrode 20 sandwich a phosphoric acid salt-based solid electrolyte layer 30 therebetween. The first electrode 10 is located on a first main face of the solid electrolyte layer 30. The first electrode 10 has a structure in which a first electrode layer 11 and a first current collector layer 12 are stacked. The first electrode layer 11 is on the solid electrolyte layer 30 side. The second electrode 20 is located on a second main face of the solid electrolyte layer 30. The second electrode 20 has a structure in which a second electrode layer 21 and a second current collector layer 22 are stacked. The second electrode layer 21 is on the solid electrolyte layer 30 side.

When the all-solid battery 100 is used as a secondary battery, one of the first electrode 10 and the second electrode 20 is used as a positive electrode, and the other is used as a negative electrode. In the present embodiment, as an example, the first electrode 10 is used as a positive electrode and the second electrode 20 is used as a negative electrode.

At least, the solid electrolyte layer 30 is a phosphoric acid salt-based solid electrolyte. The phosphoric acid salt-based solid electrolyte has, for example, a NASICON structure. The phosphoric acid salt-based solid electrolyte having a NASICON structure has a high conductivity and is stable in normal atmosphere. The phosphoric acid salt-based solid electrolyte is, for example, such as a salt of phosphoric acid including lithium. Examples of the salt of phosphoric acid include, but are not limited to, a composite salt of phosphoric acid with Ti (for example, LiTi₂ (PO₄)₃). Alternatively, at least a part of Ti may be replaced with a quadrivalent transition metal such as, but not limited to, Ge, Sn, Hf, or Zr. To increase a content of Li, a part of Ti may be replaced with a trivalent transition metal such as, but not limited to, Al, Ga, In, Y or La. More specifically, examples of the phosphoric acid salt including lithium and having a NASICON structure include Li₁₋ₓAlₓGe₂₋ₓ (PO₄)₃, Li₁₊ₓAlₓZr₂₋ₓ (PO₄)₃, and Li₁₊ₓAlₓTi₂₋ₓ (PO₄)₃. For example, it is preferable that a Li—Al—Ge—PO₄-based material, to which a transition metal contained in the phosphoric acid salt having the olivine type crystal structure contained in the first electrode layer 11 and the second electrode layer 21 is added in advance, is used. For example, when the first electrode layer 11 and the second electrode layer 21 contain a phosphoric acid salt containing Co and Li, it is preferable that the solid electrolyte layer 30 contains a Li—Al—Ge—PO₄-based material to which Co is added in advance. In this case, it is possible to inhibit the transition metal contained in the electrode active material from solving into the electrolyte. When the first electrode layer 11 and the second electrode layer 21 contain a phosphoric acid salt containing Li and a transition element other than Co, it is preferable that the solid electrolyte layer 30 contains a Li—Al—Ge—PO₄-based material to which the transition element is added in advance.

At least, the first electrode layer 11 used as a positive electrode contains, as an electrode active material, a material having an olivine type crystal structure. It is preferable that the second electrode layer 21 also contains the electrode active material. Examples of the electrode active material include, but are not limited to, a phosphoric acid salt containing a transition metal and lithium. The olivine type crystal structure is a crystal of natural olivine. It is possible to identify the olivine type crystal structure, by using X-ray diffraction.

LiCoPO₄ containing Co may be used as a typical example of the electrode active material having the olivine type crystal structure. Other phosphoric acid salts, in which Co acting as a transition metal is replaced with another transition metal in the above-mentioned chemical formula, may be used. A ratio of Li and PO₄ may fluctuate in accordance with a valence. It is preferable to use Co, Mn, Fe, Ni, or the like as the transition metal.

The electrode active material having the olivine type crystal structure acts as a positive electrode active material in the first electrode layer 11 acting as a positive electrode. For example, when only the first electrode layer 11 contains the electrode active material having the olivine type crystal structure, the electrode active material acts as the positive electrode active material. When the second electrode layer 21 also contains an electrode active material having the olivine type crystal structure, a discharge capacity may increase and an operation voltage may increase because of electric discharge, in the second electrode layer 21 acting as a negative electrode. The function mechanism is not completely clear. However, the mechanism may be caused by partial solid-phase formation together with the negative electrode active material.

When both the first electrode layer 11 and the second electrode layer 21 contain an electrode active material having the olivine type crystal structure, the electrode active material of each of the first electrode layer 11 and the second electrode layer 21 may have a common transition metal. Alternatively, the transition metal of the electrode active material of the first electrode layer 11 may be different from that of the second electrode layer 21. The first electrode layer 11 and the second electrode layer 21 may have only a single type of transition metal. The first electrode layer 11 and the second electrode layer 21 may have two or more types of transition metal. It is preferable that the first electrode layer 11 and the second electrode layer 21 have a common transition metal. It is more preferable that the electrode active materials of the both electrode layers have the same chemical composition. When the first electrode layer 11 and the second electrode layer 21 have a common transition metal or a common electrode active material of the same composition, similarity between the compositions of the both electrode layers increases. Therefore, even when terminals of the all-solid battery 100 are connected in a positive/negative reversed state, the all-solid battery 100 can be actually used without malfunction, in accordance with the usage purpose.

The second electrode layer 21 may contain a known material as the negative electrode active material. When only one of the electrode layers contains the negative electrode active material, it is clarified that the one of the electrode layers acts as a negative electrode and the other acts as a positive electrode. When only one of the electrode layers contains the negative electrode active material, it is preferable that the one of the electrode layers is the second electrode layer 21. Both of the electrode layers may contain the known material as the negative electrode active material. Conventional technology of secondary batteries may be applied to the negative electrode active material. Examples of the negative electrode active material include, but are not limited to, titanium oxide, lithium-titanium composite oxide, lithium-titanium composite salt of phosphoric acid, a carbon, and a vanadium lithium phosphate.

In the forming process of the first electrode layer 11 and the second electrode layer 21, moreover, an oxide-based solid electrolyte material or a conductive material (conductive auxiliary agent) such as a carbon or a metal may be added. When the material is evenly dispersed into water or organic solution together with binder or plasticizer, paste for electrode layer is obtained. Pd, Ni, Cu, or Fe, or an alloy thereof may be used as a metal of the conductive auxiliary agent.

The first electric collector layer 12 and the second electric collector layer 22 contain Pd as a conductive material. Pd is hardly oxidized and hardly reacts with various materials in the process of sintering each layer by firing. Pd has high adhesion with ceramic among metals. Therefore, the first electrode layer 11 has high adhesion with the first current collector layer 12, and the second electrode layer 21 has high adhesion with the second current collector layer 22. Thus, when the first current collector layer 12 and the second current collector layer 22 contain Pd, the all-solid battery 100 has good performance. As with the conductive auxiliary agent, Pd, Ni, Cu, or Fe, or an alloy thereof may be used for the first current collector layer 12 and the second current collector layer 22. The conductive auxiliary agent of the first electrode layer 11 and the second electrode layer 21 may collect current to the external electrode without providing the first current collector layer 12 and the second current collector layer 22.

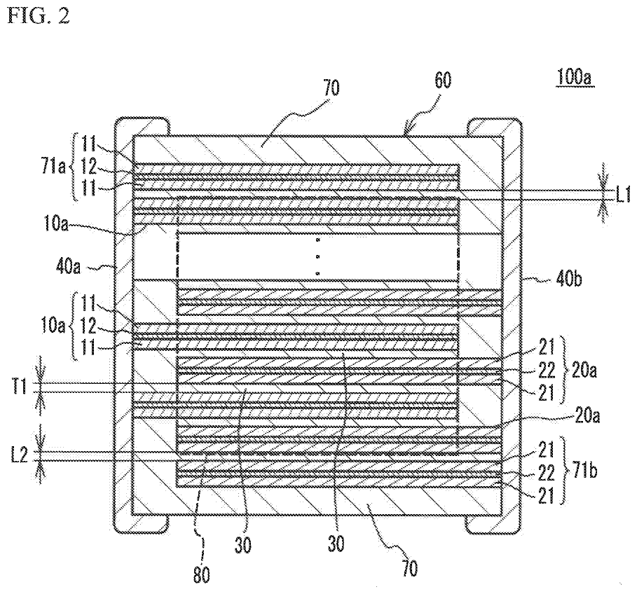

FIG. 2 is a schematic cross-sectional view of an all-solid battery 100a in which a plurality of cell units are stacked in accordance with the first embodiment. The all-solid battery 100a includes a multilayer chip 60 having a substantially rectangular parallelepiped shape, a first external electrode 40a located on a first edge face of the multilayer chip 60, and a second external electrode 40b located on a second edge face facing the first edge face.

Among the four faces other than the two edge faces of the multilayer chip 60, two faces other than the upper face and the lower face in the stacking direction are referred to as side faces. The first external electrode 40a and the second external electrode 40b extend on the upper face and the lower face in the stacking direction and two side faces of the multilayer chip 60. The first external electrode 40a and the second external electrode 40b are separated from each other.

In the following descriptions, the same reference numeral is provided to each member of the all-solid batteries having the same composition range, the same average thickness range, and the same particle size distribution range as those of the all-solid battery 100, and the description thereof is thus omitted.

In the all-solid battery 100a, the solid electrolyte layers 30 and the electrodes (a first electrode 10a and a second electrode 20a) are alternately stacked. More specifically, the solid electrolyte layer 30 is stacked on the second electrode 20a. The solid electrolyte layer 30 extends from the first external electrode 40a to the second external electrode 40b. The first electrode 10a is stacked on the solid electrolyte layer 30. Another solid electrolyte layer 30 is stacked on the first electrode 10a. The solid electrolyte layer 30 extends from the first external electrode 40a to the second external electrode 40b. In the all-solid battery 100a, the stack units are repeatedly stacked. Therefore, the all-solid battery 100a has a structure in which a plurality of cell units are stacked.

Edges of the first electrodes 10a are exposed to the first edge face of the multilayer chip 60 but are not exposed to the second edge face. Edges of the second electrodes 20a are exposed to the second edge face of the multilayer chip 60 but are not exposed to the first edge face. Thus, the first electrodes 10a and the second electrodes 20a are alternately electrically connected to the first external electrode 40a and the second external electrode 40b.

The first electrode 10a has a structure in which the first electrode layer 11, the first current collector layer 12, and another first electrode layer 11 are stacked in this order, while the second electrode 20a has a structure in which the second electrode layer 21, the second current collector layer 22, and another second electrode layer 21 are stacked in this order. The first electrode 10a may have a structure in which only one first electrode layer 11 is provided. Alternatively, the first electrode 10a may have a structure in which the first electrode layer 11 is stacked on the first current collector layer 12 located on the first main face of the solid electrolyte layer 30, as with the first electrode 10 illustrated in FIG. 1. The second electrode 20a may have a structure in which only one second electrode layer 21 is provided.

Alternatively, the second electrode 20a may have a structure in which the second electrode layer 21 is stacked on the second current collector layer 22 located on the second main face of the solid electrolyte layer 30, as with the second electrode 20 illustrated in FIG. 1.

As illustrated in FIG. 2, the region where the first electrode 10a connected to the first external electrode 40a and the second electrode 20a connected to the second external electrode 40b face each other across the solid electrolyte layer 30 is the region in which the cell reaction occurs in the all-solid battery 100a. Thus, this region will be referred to as a cell reaction region 80. That is, the cell reaction region 80 is a region where two adjacent electrodes (the first electrode 10a and the second electrode 20a) connected to different external electrodes face each other across the solid electrolyte layer 30.

A cover layer 70 is located between the upper face of the multilayer chip 60 and the cell reaction region 80, and another cover layer 70 is located between the lower face of the multilayer chip 60 and the cell reaction region 80. To enhance the strength and inhibit water intrusion, it is preferable that the main component of the cover layer 70 is a material to be densely sintered at the temperature at which the multilayer chip 60 is fired. Thus, the cover layer 70 may have the same composition as that of, for example, the solid electrolyte layer 30, or the main component of the cover layer 70 may be the same as that of the solid electrolyte layer 30.

The material of the cover layer 70 is not particularly limited as long as it is phosphoric acid salt-based solid electrolyte. For example, the phosphoric acid salt-based solid electrolyte having a NASICON structure may be used for the cover layer 70. The phosphoric acid salt-based solid electrolyte is, for example, a phosphoric acid salt containing lithium. The phosphoric acid salt is not particularly limited, and examples of the phosphoric acid salt include, but are not limited to, a composite lithium salt of phosphoric acid with Ti (e.g., LiTi₂ (PO₄)₃). Alternatively, at least a part of Ti may be replaced with a quadrivalent transition metal such as, but not limited to, Ge, Sn, Hf, or Zr. To increase a content of Li, a part of Ti may be replaced with a trivalent transition metal such as, but not limited to, Al, Ga, In, Y or La. Examples of the phosphoric acid salt including lithium and having a NASICON structure include Li₁₋ₓAlₓGe₂₋ₓ (PO₄)₃, Li₁₊ₓAlₓZr₂₋ₓ (PO₄)₃, and Li₁₊ₓAlₓTi₂₋ₓ (PO₄)₃.

However, use of the above-described material for the cover layers 70 causes the interdiffusion reaction between the cover layers 70 and the first electrode 10a and the second electrode 20a, which are in contact with the cover layers 70, and thereby, the compositions inside the outermost first electrode 10a and the outermost second electrode 20a in the cell reaction region 80 may change to a composition different from the composition inside the electrode near the center of the cell reaction region 80. It is concerned that the change in the composition decreases the capacitance.

Thus, in the multilayer chip 60 of the all-solid battery 100a in accordance with the present embodiment, as illustrated in FIG. 2, active material layers (hereinafter, referred to as dummy electrodes) 71a and 71b are provided between the cover layer 70 and the cell reaction region 80. The solid electrolyte layer 30 is provided between the dummy electrodes 71a and 71b and the cell reaction region 80.

In the first embodiment, the edge of the dummy electrode 71a is coupled to the first external electrode 40a to which the first electrode 10a closest to the upper face of the multilayer chip 60 is connected, but is not connected to the second external electrode 40b. That is, the edge of the dummy electrode 71a is not connected to at least the second external electrode 40b different from the first external electrode 40a to which the first electrode 10a closest to the upper face of the multilayer chip 60 is connected. Thus, cell reaction does not occur between the dummy electrode 71a and the first electrode 10a closest to the upper face of the multilayer chip 60.

The edge of the dummy electrode 71b is connected to the second external electrode 40b to which the second electrode 20a closest to the lower face of the multilayer chip 60 is connected, but is not connected to the first external electrode 40a. That is, the edge of the dummy electrode 71b is not connected to at least the first external electrode 40a different from the second external electrode 40b to which the second electrode 20a closest to the lower face of the multilayer chip 60 is connected. Thus, cell reaction does not occur between the dummy electrode 71b and the second electrode 20a closest to the lower face of the multilayer chip 60.

The dummy electrodes 71a and 71b contain an electrode active material. In the first embodiment, it is preferable that the dummy electrode 71a provided in the cover layer 70 between the cell reaction region 80 and the upper face of the multilayer chip 60 contains the electrode active material contained in the first electrode layer 11 of the first electrode 10a closest to the upper face of the multilayer chip 60 in the cell reaction region 80. It is more preferable that the dummy electrode 71a has the same layer structure as the first electrode 10a closest to the upper face of the multilayer chip 60. That is, it is more preferable that the dummy electrode 71a has a structure in which the first electrode layer 11, the first current collector layer 12, and another first electrode layer 11 are stacked. It is further preferable that the dummy electrode 71a has the same layer structure as the first electrode 10a and the average thicknesses of the layers of the dummy electrode 71a are the same as the average thicknesses of the respective layers of the first electrode 10a. That is, it is further preferable that the dummy electrode 71a has a structure in which the first electrode layer 11, the first current collector layer 12, and another first electrode layer 11 are stacked and the average thicknesses of the first electrode layer 11, the first current collector layer 12, and another first electrode layer 11 of the dummy electrode 71a are respectively equal to the average thicknesses of the first electrode layer 11, the first current collector layer 12, and another first electrode layer 11 of the first electrode 10a. In addition, it is preferable that the distance L1 between the outermost first electrode 10a in the cell reaction region 80 and the dummy electrode 71a is equal to the thickness T1 of the solid electrolyte layer 30 in the cell reaction region 80, and it is further preferable that the part between the outermost first electrode 10a in the cell reaction region 80 and the dummy electrode 71a has the same composition as the solid electrolyte layer 30.

In the first embodiment, it preferable that the dummy electrode 71b provided in the cover layer 70 between the cell reaction region 80 and the lower face of the multilayer chip 60 contains the electrode active material contained in the second electrode layer 21 of the second electrode 20a closest to the lower face of the cell reaction region 80. It is more preferable that the dummy electrode 71b has the same layer structure as the second electrode 20a closest to the lower face of the multilayer chip 60 in the multilayer chip 60. That is, it is more preferable that the dummy electrode 71b has a structure in which the second electrode layer 21, the second current collector layer 22, and another second electrode layer 21 are stacked. It is further preferable that the dummy electrode 71b has the same layer structure as the second electrode 20a and the average thicknesses of the layers of the dummy electrode 71b are equal to the average thicknesses of the respective layers of the second electrode 20a. That is, it is further preferable that the dummy electrode 71b has a structure in which the second electrode layer 21, the second current collector layer 22, and another second electrode layer 21 are stacked and the average thicknesses of the second electrode layer 21, the second current collector layer 22, and another second electrode layer 21 of the dummy electrode 71b are respectively equal to the average thicknesses of the second electrode layer 21, the second current collector layer 22, and another second electrode layer 21 of the second electrode 20a. It is preferable that the distance L2 between the outermost second electrode 20a in the cell reaction region 80 and the dummy electrode 71b is equal to the thickness T1 of the solid electrolyte layer 30 in the cell reaction region 80, and it is further preferable that the part between the outermost second electrode 20a in the cell reaction region 80 and the dummy electrode 71b has the same composition as the solid electrolyte layer 30.

Since the dummy electrodes 71a and 71b are provided in locations closest to the cover layers 70, the dummy electrodes 71a and 71b are preferentially affected by the respective cover layers 70 compared with the electrodes (the first electrode 10a, the second electrode 20a) in the cell reaction region 80. Thus, the elemental diffusion from the active material contained in the cell reaction region 80 is inhibited, and even when the cover layers 70 and the dummy electrodes 71a and 71b react on one another, since cell reaction does not inherently occur between the cover layers 70 and the dummy electrodes 71a and 71, the capacitance of the entire all-solid battery does not change, and the decrease in capacitance is inhibited.

### Second Embodiment

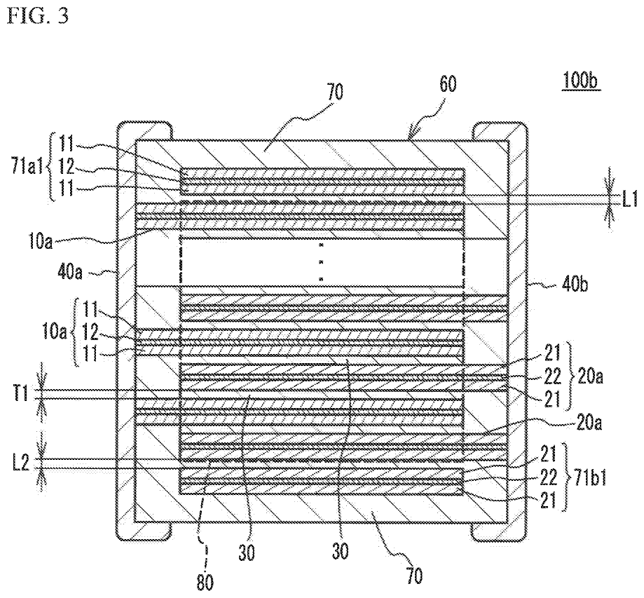

FIG. 3 is a cross-sectional view illustrating an overall structure of an all-solid battery 100b in accordance with a second embodiment. As illustrated in FIG. 3, in the second embodiment, a dummy electrode 71a1 provided in the cover layer 70 between the cell reaction region 80 and the upper face of the multilayer chip 60 is connected to neither the first external electrode 40a nor the second external electrode 40b. A dummy electrode 71b1 provided in the cover layer 70 between the cell reaction region 80 and the lower face of the multilayer chip 60 is connected to neither the first external electrode 40a nor the second external electrode 40b. Other structures are the same as those of the all-solid battery 100a in accordance with the first embodiment, and the detailed description thereof is thus omitted. Also in the all-solid battery 1006 of the second embodiment, the dummy electrodes 71a1 and 71b1 are provided in locations closest to the cover layers 70. Thus, the dummy electrodes 71a1 and 71b1 are preferentially affected by the cover layers 70 compared with the electrodes (the first electrode 10a, the second electrode 20a) in the cell reaction region 80. Since the cell reaction does not occur between the dummy electrodes 71a1 and 71b1 and the cover layers 70, the capacitance of the cell reaction region 80 does not change, and thereby, decrease in the capacitance is inhibited.

In the second embodiment, it is sufficient if the dummy electrodes 71a1 and 71b1 contain an electrode active material. It is preferable that the dummy electrodes 71a1 and 71b1 contain the electrode active material contained in any one of the first electrode layer 11 of the outermost first electrode 10a in the cell reaction region 80 and the second electrode layer 21 of the outermost second electrode 20a in the cell reaction region 80. It is more preferable that the dummy electrodes 71a1 and 71b1 have the same layer structure as any one of the outermost first electrode 10a and the outermost second electrode 20a in the cell reaction region 80. It is further preferable that the dummy electrodes 71a1 and 71b1 have the same layer structure as any one of the outermost first electrode 10a and the outermost second electrode 20a in the cell reaction region 80 and the average thicknesses of the layers of the dummy electrodes 71a1 and 71b1 are equal to the average thicknesses of the respective layers of the any one of the first electrode 10a and the second electrode 20a.

In the first and second embodiments, to minimize the difference between the inter reaction between the electrode layer and the solid electrolyte layer 30 near the center of the cell reaction region 80 and the inter reaction between the electrode layer and the solid electrolyte layer 30 near the outermost part of the cell reaction region 80, it is preferable that both the distance L1 between the dummy electrode 71a, 71a1 and the outermost first electrode 10a in the cell reaction region 80 (the first electrode 10a closest to the upper face of the multilayer chip 60) and the distance L2 between the dummy electrode 71b, 71b1 and the outermost second electrode 20a in the cell reaction region 80 (the second electrode 20a closest to the lower face of the multilayer chip 60) are substantially equal to the average thickness T1 in the stacking direction of the solid electrolyte layer of the layer structure.

In the first and second embodiments, two or more dummy electrodes 71a, 71a1, 71b, 71b1 may be located between the cover layer 70 and the cell reaction region 80.

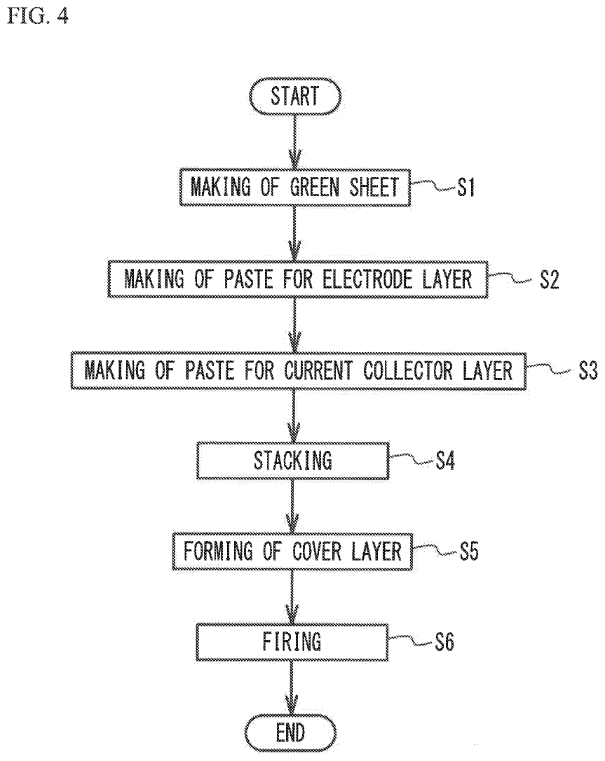

Next, a method of manufacturing the all-solid battery 100a will be described. FIG. 4 is a flowchart of the method of manufacturing the all-solid battery 100a.

Making Process of Green Sheet

Powder of the phosphoric acid salt-based solid electrolyte structuring the solid electrolyte layer 30 is made. For example, it is possible to make the powder of the phosphoric acid salt-based solid electrolyte structuring the solid electrolyte layer 30, by mixing raw materials and additives and using solid phase synthesis method or the like. The resulting powder is subjected to dry grinding. Thus, a grain diameter of the resulting power is adjusted to a desired one.

The resulting powder is evenly dispersed into aqueous solvent or organic solvent together with a binding agent, a dispersing agent, a plasticizer and so on. The resulting power is subjected to wet crushing. Thereby, solid electrolyte slurry having a desired grain diameter is obtained. In this case, a bead mill, a wet jet mill, a kneader, a high pressure homogenizer or the like may be used. It is preferable that the bead mill is used because adjusting of particle size distribution and dispersion are performed at the same time. A binder is added to the resulting solid electrolyte slurry. Thus, solid electrolyte paste is obtained. A green sheet is obtained by applying the solid electrolyte paste. The application method is not limited to a particular method. For example, a slot die method, a reverse coat method, a gravure coat method, a bar coat method, a doctor blade method or the like may be used. It is possible to measure grain diameter distribution after the wet crushing, with use of a laser diffraction measuring device using a laser diffraction scattering method.

Making process of Paste for Electrode Layer

Next, paste for electrode layer is made in order to make the first electrode layer 11 and the second electrode layer 21. For example, a conductive auxiliary agent, an active material, a solid electrolyte material, a binder, a plasticizer and so on are evenly dispersed into water or organic solvent. Thereby, paste for electrode layer is obtained. The above-mentioned solid electrolyte paste may be used as the solid electrolyte material. A carbon material such as Pd, Ni, Cu, Fe, or an alloy thereof may be used as the conductive auxiliary agent. When the composition of the first electrode layer 11 is different from that of the second electrode layer 21, paste for electrode layer used for the first electrode layer 11 and another paste for electrode layer used for the second electrode layer 21 may be individually made.

### Making Process of Paste for Current Collector Layer

Next, paste for current collector layer is made in order to make the first current collector layer 12 and the second current collector layer 22. For example, powder of Pd, particulate carbon black, a plate graphite carbon, a binder, a dispersant, a plasticizer and so on are evenly dispersed into water or organic solvent. Thereby, paste for current collector layer is obtained. When the composition of the first current collector layer 12 is different from the composition of the second current collector layer 22, paste for the first current collector layer 12 and another paste for the second current collector layer 22 may be individually made.

### Stacking Process

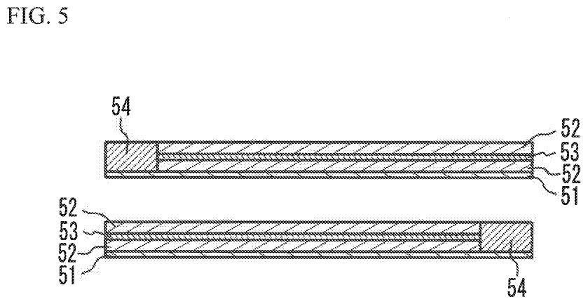

As illustrated in FIG. 5, paste 52 for electrode layer is printed on one face of a green sheet 51. Then, paste 53 for current collector layer is printed on the paste 52 for electrode layer. Then, another paste 52 for electrode layer is printed on the paste 53 for current collector layer. A reverse pattern 54 is printed on a part of the green sheet 51 where neither the paste 52 for electrode layer nor the paste 53 for current collector layer is printed. A material of the reverse pattern 54 may be the same as that of the green sheet 51. The green sheets 51 after printing are stacked such that the green sheets 51 are alternately shifted from each other. Through the above process, a multilayer structure is obtained. In this case, in the multilayer structure, each pair of the paste 52 for electrode layer and the paste 53 for electric collector is alternately exposed to the two edge faces of the multilayer structure. Only the electrode layers may be formed without providing the current collector layers. In this case, the electrode layers and the reverse pattern layers are printed and formed.

### Forming Process of Cover Layer

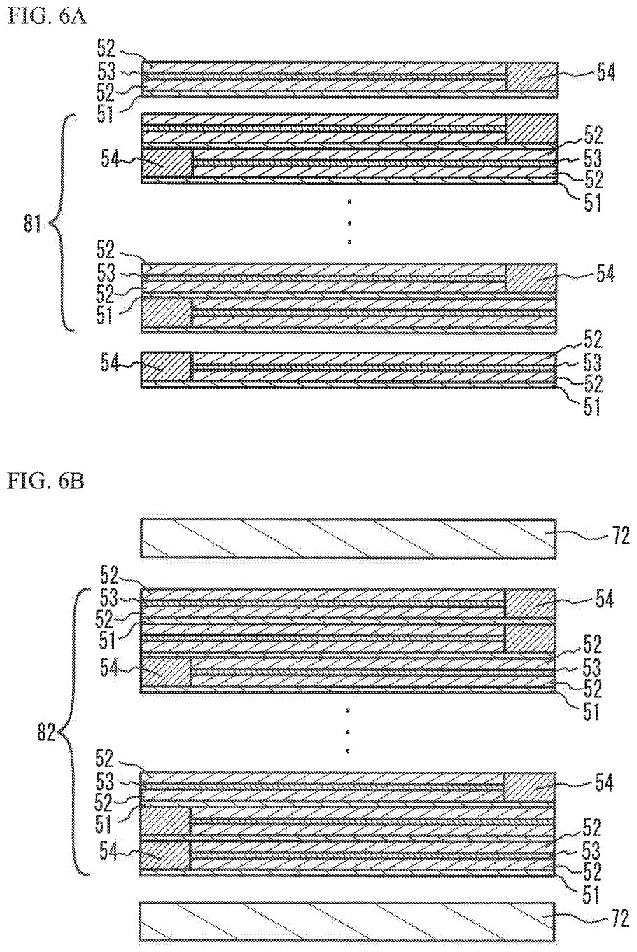

As illustrated in FIG. 6A, a green sheet 51 after printing is arranged on a multilayer structure 81 obtained through the stacking process such that a pair of the paste 52 for electrode layer and the paste 53 for current collector layer formed on the green sheet 51 is exposed to the edge face to which the pair of the paste 52 for electrode layer and the paste 53 for current collector layer located in the uppermost part of the multilayer structure 81 is exposed. In addition, another green sheet 51 after printing is arranged under the multilayer structure 81 such that a pair of the paste 52 for electrode layer and the paste 53 for current collector layer formed on the green sheet 51 is exposed to the edge face to which the pair of the paste 52 for electrode layer and the paste 53 for current collector layer located in the lowermost part of the multilayer structure 81 is exposed.

Then, cover sheets 72 are arranged on and under a resulting multilayer structure 82, and then bonded by pressurizing.

In the all-solid battery 100 of the first embodiment, when the first electrode layer 11 and the second electrode layer 21 have the same composition and the first current collector layer 12 and the second current collector layer 22 have the same composition, the patterns used for forming the first electrode 10a, the second electrode 20a, and the dummy electrodes 71a and 71b are the same. Thus, manufacture is easy.

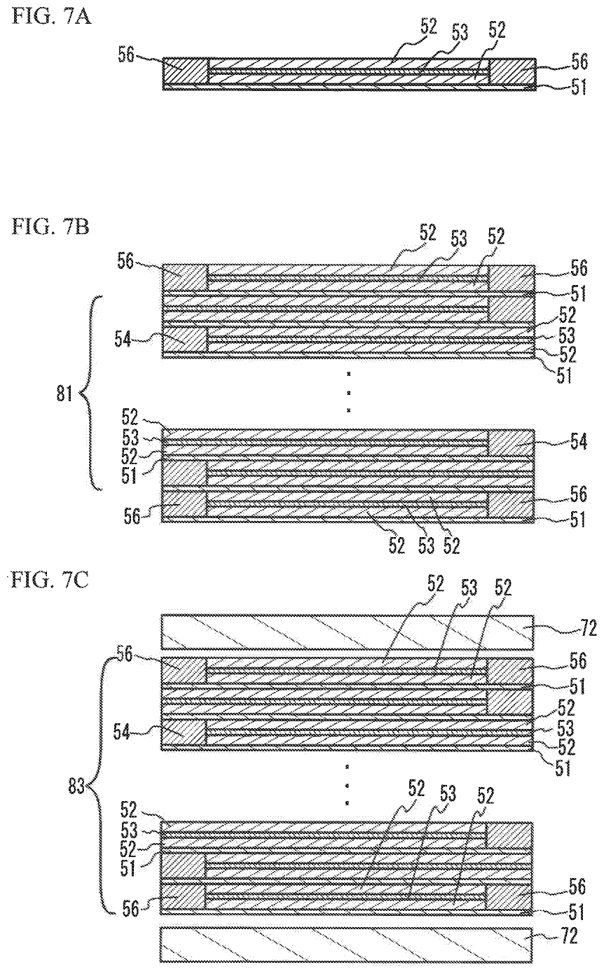

In the all-solid battery 100b of the second embodiment, as illustrated in FIG. 7A, the paste 52 for electrode layer is printed on the green sheet 51, the paste 53 for current collector layer is then printed on the paste 52 for electrode layer, and another paste 52 for electrode layer is printed on the paste 53 for current collector layer. A reverse pattern 56 is printed on a part of the green sheet 51 where neither the paste 52 for electrode layer nor the paste 53 for current collector layer is printed. The material of the reverse pattern 56 may be the same as that of the green sheet 51. Thereafter, the green sheets 51 after printing are arranged on and under the multilayer structure 81 as illustrated in FIG. 7B. Thereafter, as illustrated in FIG. 7C, the cover sheets 72 are arranged on and under a multilayer structure 83 and bonded by pressurizing.

In the all-solid battery 100b of the second embodiment, when the first electrode layer 11 and the second electrode layer 21 have the same composition and the first current collector layer 12 and the second current collector layer 22 have the same composition, the patterns used for forming the dummy electrodes 71a1 and 71b1 are the same. Thus, manufacture is easy compared with the case where the first electrode layer 11 and the second electrode layer 21 have different compositions and the first current collector layer 12 and the second current collector layer 22 have different compositions.

Firing Process

Next, the obtained multilayer structure is fired. In the firing process, it is preferable that a maximum temperature is 400° C. to 1000° C. under an oxidizing atmosphere or a non-oxidizing atmosphere. It is more preferable that a maximum temperature is 500° C. to 900° C. under an oxidizing atmosphere or a non-oxidizing atmosphere. In order to sufficiently remove the binder before the temperature reaches the maximum temperature, a process for maintaining the temperature at a temperature lower than the maximum temperature in an oxidizing atmosphere may be performed. It is preferable that the firing is performed at as low temperature as possible to reduce the process cost. After the firing, a re-oxidizing process may be performed. Through the above processes, the multilayer chip 60 is manufactured.

### Forming Process of External Electrode

Thereafter, metal paste is applied to two edge faces of the multilayer chip 60 and then fired. This process forms the first external electrode 40a and the second external electrode 40b. The first external electrode 40a and the second external electrode 40b may be formed by plating the electrodes after firing.

### EXAMPLES

The all-solid battery in accordance with the embodiment was fabricated and the property was measured.

### Example 1

Co₃O₄, Li₂CO₃, ammonium dihydrogenphosphate, Al₂O₃, and GeO₂ were mixed to make, as powder of solid electrolyte material, Li_{1.3}Al_{0.3}Ge_{1.7} (PO₄)₃ containing a predetermined amount of Co by solid-phase synthesis. The resulting powder was dry-milled with ZrO₂ balls with a diameter of 5 mm (a planetary boll mill at 400 rpm for 30 minutes) till the particle diameter D90 was 10 μm or less. Then, the dry-milled powder was further wet-milled (disperse medium: a mixed solvent of ethanol and toluene) by beads with a diameter of 1.5 mm till the particle diameter D90 was 3 μm and the particle diameter D50 was 0.5 μm. Through these processes, solid electrolyte slurry was obtained. A binder and a plasticizer were added to the obtained slurry. The resulting solid electrolyte slurry was processed into a green sheet with a thickness of 10 μm by the doctor blade method. Li_{1.3}Al_{0.3}Ti_{1.7} (PO₄)₃ containing a predetermined amount of LiCoPO₄ and a predetermined amount of Co was made by solid-phase synthesis. The resulting powder was then wet-milled, and dispersed to make slurry. A binder, a plasticizer, a dispersant, and Pd paste were added to the slurry to prepare paste for electrode layer.

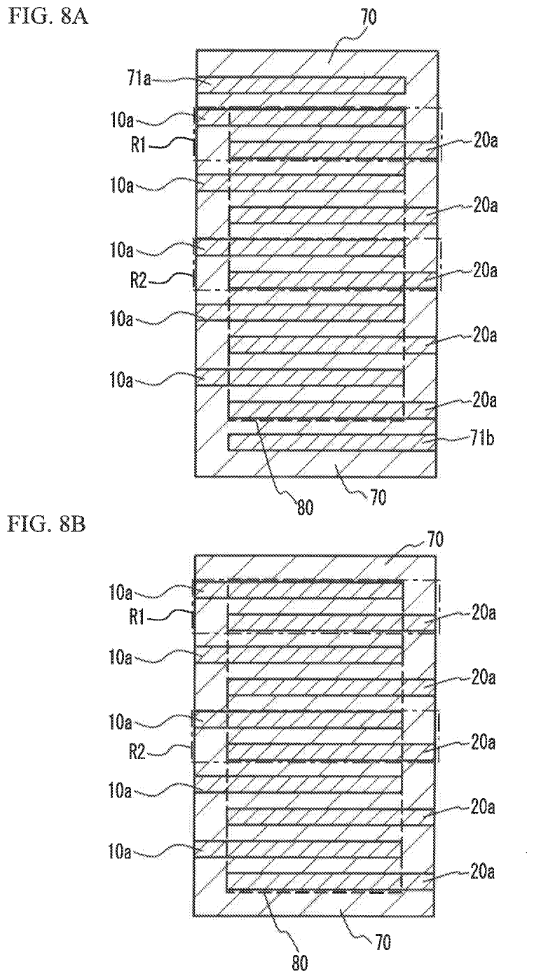

The paste for electrode layer was printed, in a thickness of 2 μm, on the green sheet with use of a screen with a predetermined pattern. Then, Pd paste, as paste for current collector layer, was printed, in a thickness of 2 μm, on the printed paste for electrode layer. Then, another paste for electrode layer was printed, in a thickness of 2 μm, on the printed paste for current collector layer. Ten sheets after printing were shifted to each other and stacked such that electrodes are alternately exposed to the right and the left to obtain a multilayer structure as illustrated in FIG. 8A. One sheet after printing for forming the dummy electrode was stacked on the top of the obtained multilayer structure, and another sheet after printing was stacked on the bottom of the obtained multilayer structure. Thereafter, a cover layer formed of stacked green sheets was attached to each of the top and the bottom, and bonded by heating and pressing. Then, the multilayer structure was cut into a multilayer structure having a predetermined size by a dicer.

The 100 chips after cutting were degreased by heat treatment at 300° C. or greater and 500° C. or less, and were then sintered by heat treatment at 900° C. or less. Through this process, sintered compacts were obtained.

### First Comparative Example

In a first comparative example, ten sheets after printing were shifted to each other and stacked such that electrodes are alternately exposed to the right and the left as illustrated in FIG. 8B, and then cover layers formed of stacked green sheets were attached to the top and the bottom. That is, in the first comparative example, no dummy electrode was provided. Other conditions were the same as those of the first embodiment.

### Analysis

In the first embodiment and the first comparative example, only a pair of the first electrode 10a and the second electrode 20a included in the uppermost part of the cell reaction region 80 (the part indicated by R1 in FIG. 8A and FIG. 8B) was connected to the external electrode, and the capacitance (hereinafter, referred to as the capacitance of the outermost layer for convenience sake) was measured. In addition, only a pair of the first electrode 10a and the second electrode 20a located in the center part of the cell reaction region 80 indicated by R2 in FIG. 8A and FIG. 8B (more specifically, the fifth and sixth electrodes from the top of the cell reaction region 80) was connected to the external electrode, and the capacitance (hereinafter, referred to as the capacitance of the center part for convenience sake) was measured.

In the first embodiment, the capacitance of the outermost layer and the capacitance of the center part were substantially the same. On the other hand, in the first comparative example, the capacitance of the outermost layer was approximately 70% of the capacitance of the center part. This is considered because, since the dummy electrodes 71a and 71b were not provided in the first comparative example, the interdiffusion reaction was not inhibited.

Although the embodiments of the present invention have been described in detail, it is to be understood that the various change, substitutions, and alterations could be made hereto without departing from the spirit and scope of the invention.

What is claimed is:

1. An all-solid battery comprising:
a multilayer chip having a substantially rectangular parallelepiped shape and including solid electrolyte layers and electrodes that are alternately stacked, the electrodes being alternately exposed to two edge faces facing each other of the multilayer chip, the solid electrolyte layers being mainly composed of phosphoric acid salt-based solid electrolyte; and
a pair of external electrodes provided on the two edge faces, wherein
a pair of cover layers is provided between two faces of four faces other than the two edge faces of the multilayer chip and a cell reaction region, the two faces facing in a stacking direction of the solid electrolyte layers and the electrodes, the cell reaction region being a region where two adjacent electrodes, which are exposed to different edge faces, face each other across the solid electrolyte layer, and
an active material layer is provided between the pair of cover layers and the cell reaction region, the active material layer containing an electrode active material, no cell reaction occurring between the active material layer and an outermost electrode of the electrodes in the cell reaction region, the solid electrolyte layer being located between the active material layer and the cell reaction region.

2. The all-solid battery according to claim 1, wherein
the electrodes have a structure in which a current collector layer is sandwiched between two electrode layers containing an electrode active material.

3. The all-solid battery according to claim 2, wherein
the active material layer contains the electrode active material contained in the electrode layer of the outermost electrode in the cell reaction region.

4. The all-solid battery according to claim 1, wherein
the active material layer has a structure identical to a structure of the outermost electrode in the cell reaction region.

5. The all-solid battery according to claim 4, wherein
an average thickness of each layer of the dummy electrode is identical to an average thickness of a corresponding layer of the outermost electrode in the cell reaction region.

6. The all-solid battery according to claim 1, wherein
the active material layer includes a first active material layer and a second active material layer, the first active material layer being located between the cover layer closer to a first face of the two faces facing each other and the cell reaction region, the first active material layer not being connected to at least an external electrode different from an external electrode to which an electrode closest to the first face among the electrodes included in the cell reaction region is connected, the second active material layer being located between the cover layer closer to a second face of the two faces facing each other and the cell reaction region, the second active material layer not being connected to at least an external electrode different from an external electrode to which an electrode closest to the second face among the electrodes included in the cell reaction region is connected.

7. The all-solid battery according to claim 1, wherein
the active material layer is connected to none of the pair of external electrodes.

8. The all-solid battery according to claim 1, wherein
a distance between the active material layer and the outermost electrode in the cell reaction region in the stacking direction is substantially equal to an average thickness in the thickness direction of the solid electrolyte sandwiched between the electrodes exposed to the different edge faces in the cell reaction region.

9. The all-solid battery according to claim 1, wherein
the cover layer is mainly composed of the phosphoric acid salt-based solid electrolyte identical to a main component of the solid electrolyte layer.

10. The all-solid battery according to claim 1, wherein
the phosphoric acid salt-based solid electrolyte has a NASICON structure.
